(19) United States
(12) Patent Application Publication
(10) Pub. No.: US 2007/0086371 A1
(43) Pub. Date: Apr. 19, 2007

(54) Controlled multi-user packet detection for a wireless packet data channel

(75) Inventors: Mahesh A. Makhijani, San Diego, CA (US); Thawatt Gopal, San Diego, CA (US)

Correspondence Address: COATS & BENNETT, PLLC, 1400 Crescent Green, Suite 300, Cary, NC, 27518, US

(73) Assignee: Telefonaktiebolaget LM Ericsson

(21) Appl. No.: 11/252,065

(22) Filed: Oct. 17, 2005

(51) Int. Cl. H04L 12/26; H04Q 7/00; H04J 3/26; H04L 1/00

(52) U.S. Cl. 370/328; 370/432; 370/229

(57) ABSTRACT

Multi-user packet detection at multiple mobile stations in a sector may be collectively disabled via a downlink point-to-multipoint command message from a base station. The point-to-multipoint command message may be transmitted on a packet data control channel, typically code division multiplexed, and may be a portion of a QUICKCONFIG message and/or transmitted using less than all of the carrier frequencies used by the base station to transmit downlink packet data. Multi-user packet detection may be subsequently allowed by transmitting a second point-to-multipoint message. The multi-user detection process may comprise checking a portion of a packet against a predetermined list of possible values that indicate the presence of a multi-user packet. The relevant multipoint multi-user packet disable command may be logically ANDed at the mobile station with another mobile station setting based on point-to-point message from the base station to establish the enablement/disablement of the multi-user detection process.

### BACKGROUND OF THE INVENTION

The present invention relates to mobile communication systems; and, more particularly, to methods of handling multi-user packets transmitted on a time shared downlink packet data channel.

The demand for wireless data services, such as mobile Internet, video streaming, and voice over IP (VoIP), have led to the development of high speed packet data channels to provide high data rates needed for such services. High speed packet data channels are employed on the forward link in a variety of mobile communication systems, including IS-2000 (also known as 1xEV-DV), 1xEV-DO, and Wideband Code Division Multiple Access (WCDMA) systems. The high speed packet data channel is a time shared channel, with downlink transmissions, e.g., from a base station to the mobile stations, time-multiplexed and typically transmitted at full power.

For many of such systems, the base station may choose whether to transmit a given downlink physical layer data packet to one mobile station or to multiple mobile stations. Typically, this decision is made by a scheduler in the base station based on a number of factors including the presence or absence of queued data, the number of mobile stations, types of services involved, quality of service considerations, and the like. If the base station transmits a multi-user packet, the base station indicates the presence of a multi-user packet, such as by applying one of several pre-defined multi-user preamble MAC indexes reserved for multi-user packets.

Mobile stations receiving packet transmissions generally avoid decoding the packet if the packet is not intended for them. However, for multi-user packets, the situation is more complicated. For multi-user packets, a given mobile station may have to process the packet to a significant degree in order to see if the packet contains data for it. This involves intense processing on the part of the mobile station, to not only blind rate detect, but to also decode the packet to determine if it contains any relevant data. In contrast, if the base station transmits only “single user” packets, these packets are addressed directly to a specific mobile station via a message preamble, which is simpler to handle. Thus, if the packet is intended for another mobile station, the not-addressed-to mobile stations may quickly and easily detect this and avoid the significant processing load required to blind rate detect and decode the packet.

Multi-user packets are increasingly utilized in modern wireless communications systems, particularly for handling VoIP traffic. However, if all multi-user packets are required to be processed by a mobile station, including a significant number of multi-user packets not having data for that mobile station, then battery power is wasted. Thus, unnecessary processing multi-user packets by the mobile stations should be avoided.

Under some existing protocols, the base station may instruct a mobile station to not process multi-user packets on an individual mobile station-by-mobile station basis. This may be accomplished using, for example, an attribute known as MultiUserPacketsEnabled in systems using IS-856 Rev. A protocols. In the IS-856 Rev. A protocols, this attribute is typically negotiated and configured using the so-called Generic Attribute Update Protocol (GUAP). However, having the base station individually contact several mobile stations one-by-one to enable and disable multi-user packet processing is cumbersome, particularly on a dynamic basis.

Accordingly, there remains a need for alternative approaches to handling multi-user packets on high speed packet data channels.

### SUMMARY OF THE INVENTION

Multi-user packet detection processes at multiple mobile stations in a sector may be collectively disabled via a downlink point-to-multipoint command message from a base station. The point-to-multipoint command message may be transmitted on a packet data control channel, typically using code division multiplexing, and may be a portion of a QuickConfig message. The multi-user packet detection process may be subsequently allowed by transmitting a second point-to-multipoint message on the packet data control channel. The point-to-multipoint messages may be transmitted on less than all (e.g., only one) of the carrier frequencies used by the base station to transmit downlink packet data. The multi-user detection process may involve the mobile station checking a portion of a packet against a predetermined list of possible values that indicate the presence of a multi-user packet. The relevant multipoint multi-user packet disable command may be logically ANDed at the mobile station with another mobile station setting based on point-to-point message from the base station to establish the enablement/disablement of the multi-user detection process.

In one embodiment, the present invention provides a method of operating a base station, the base station operative to transmit multi-user packets on a downlink packet data traffic channel shared by a plurality of mobile stations. The method comprises: collectively disabling a multi-user packet detection process of a plurality of mobile stations by transmitting a first downlink point-to-multipoint command message from a base station to the plurality of mobile stations in a point-to-multipoint fashion. The first downlink point-to-multipoint command message may be transmitted on a packet data control channel, and may be a portion of a QuickConfig message. The disabling the multi-user packet detection process by the plurality of mobile stations may be for a control cycle duration. The process may continue and further comprise subsequently collectively allowing the multi-user packet detection process by the plurality of mobile stations by transmitting a second downlink point-to-multipoint command message from the base station to the plurality of mobile stations in a point-to-multipoint fashion. The plurality of mobile stations may comprise all of the mobile stations in a sector being served by the base station. A corresponding apparatus is also described.

In another embodiment, a method of operating a mobile station is disclosed that allows a multi-user packet detection process to be disabled based on receipt of a particular message from the base station. The method comprises: receiving a first point-to-multipoint message from a base station; the first message having a command indicator that instructs receiving mobile stations, in response to receiving the command indicator, to disable multi-user packet detection; disabling, at the mobile station, a multi-user packet detection process for one or more subsequently received packets based on said command indicator. The relevant multi-user detection process may comprise checking a portion of a packet against a predetermined list of possible values that indicate the presence of a multi-user packet. The process may continue with subsequently receiving a second point-to-multipoint message from the base station; and, in response to the second message, enabling the multi-user packet detection process. The receiving the first point-to-multipoint message from the base station may comprise receiving the first point-to-multipoint message on a packet data control channel, with the command indicator optionally forming a portion of a Quickconfig message transmitted on the packet data control channel. The multi-user detection process may be disabled for a control channel cycle. The mobile station may set a first attribute to a first logical value in response receiving the first message, with enablement of the multi-user detection process depending on a logical ANDing the first attribute and a second attribute associated with multi-user packets, the second attribute set according to a point-to-point message from the base station. A corresponding apparatus is also described.

### BRIEF DESCRIPTION OF THE DRAWINGS

FIG. 1 shows an exemplary wireless communication network.

FIG. 2 shows an exemplary base station.

FIG. 3 shows an exemplary mobile station.

FIG. 4 shows a flowchart for a base station operation according to one embodiment of the present invention.

FIG. 5 shows an exemplary downlink command message.

FIG. 6 shows a flowchart for a mobile station operation according to one embodiment of the present invention.

### DETAILED DESCRIPTION OF THE INVENTION

The present invention relates to the handling of multi-user packets transmitted on a downlink packet data channel in a wireless communication system having a plurality of mobile stations operating therein. As such, a brief overview of an exemplary wireless communication system and mobile station may aid in understanding the present invention.

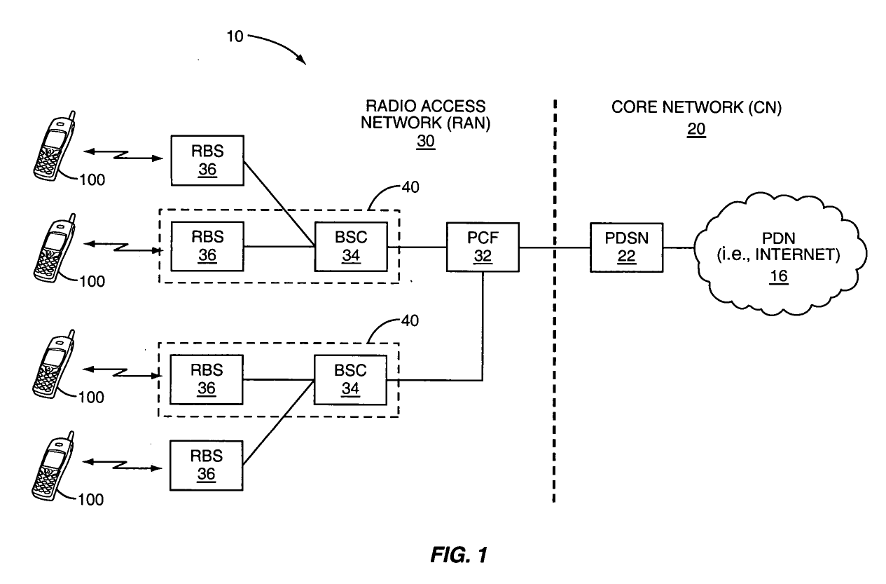

FIG. 1 illustrates the logical entities of an exemplary wireless communication network 10 that provides packet data services to mobile stations 100. In general, the wireless communication network 10 may be configured according to the IS-2000 standard, Wideband CDMA (W-CDMA) standard, 1xEV-DO standard, or other standard utilizing multi-user downlink packets. Thus, the wireless communication network 10 is a packet-switched network that employs a high-speed forward packet data channel (F-PDCH) to transmit data to the mobile stations 100. Wireless communication network 10 includes a packet-switched core network 20 and a radio access network (RAN) 30. The core network 20 includes a Packet Data Serving Node (PDSN) 22 that connects to an external packet data network (PDN) 16, such as the Internet, and supports PPP connections to and from the mobile stations 100. Core network 20 adds and removes IP streams to and from the RAN 30 and routes packets between the external packet data network 16 and the RAN 30.

RAN 30 connects to the core network 20 and gives mobile stations 100 access to the core network 20. RAN 30 includes a Packet Control Function (PCF) 32, one or more base station controllers (BSCs) 34 and one or more radio base stations (RBSs) 36. The primary function of the PCF 32 is to establish, maintain, and terminate connections to the PDSN 22. The BSCs 34 manage radio resources within their respective coverage areas. The RBSs 36 include the radio equipment for communicating over the air interface with mobile stations 100. A BSC 34 can manage more than one RBSs 36. In cdma2000 networks, a BSC 34 and an RBS 36 comprise a base station 40. The BSC 34 is the control part of the base station 40. The RBS 36 is the part of the base station 40 that includes the radio equipment and is normally associated with a cell site. In cdma2000 networks, a single BSC 34 may function as the control part of multiple base stations 40. In other network architectures, the network components comprising the base station 40 may be different, but the overall functionality will be the same or similar.

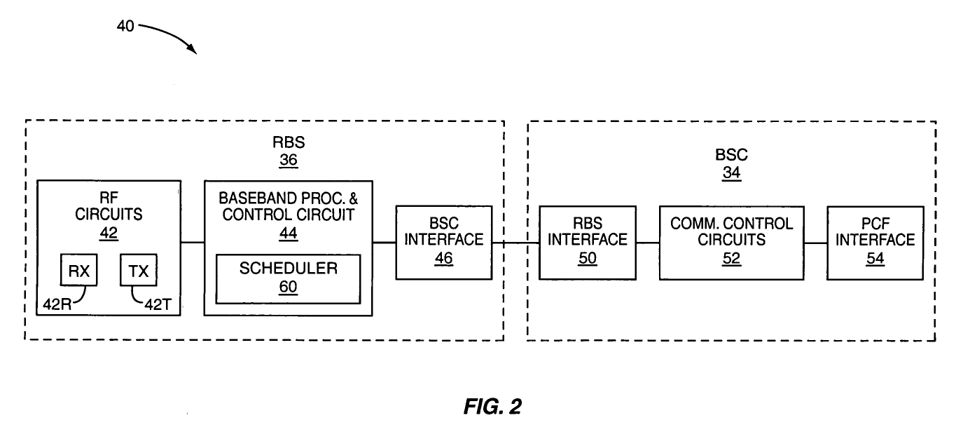

FIG. 2 illustrates exemplary details of a base station 40 in a cdma2000 network. The base station components in the exemplary embodiment are distributed between a RBS 36 and a BSC 34. The RBS 36 includes RF circuits 42, baseband processing and control circuits 44, and interface circuits 46 for communicating with the BSC 34. The RF circuits 42 include one or more transmitters 42T and receivers 42R, which transmit signals to, and receive signals from, the mobile stations 100. For example, the receiver 42T receives the channel quality indicators (CQIs) reported by the mobile stations 100 and passes the same on to the baseband processing and control circuits 44 for processing. The baseband processing and control circuits 44 perform baseband processing of transmitted and received signals. In the embodiment shown in FIG. 2, the baseband processing and control circuit 44 includes a scheduler 60 to schedule packet data transmissions on the Forward Packet Data Channel (F-PDCH). The scheduler 60 makes scheduling decisions and selects the appropriate modulation and coding schemes based on, inter alia, channel feedback from the mobile stations 100. The baseband processing and control circuit 44, including the scheduler 60, may be implemented as one or more processing circuits, comprising hardware, software, or any combination thereof, that are configured as appropriate to implement one or more of the processes described herein. For example, the baseband processing and control circuit 44 may be implemented as stored program instructions executed by one or more microprocessors or other logic circuits included in RBS 36.

The BSC 34 includes interface circuits 50 for communicating with the RBS 36, communication control circuits 52, and interface circuits 54 for communicating with PCF 32. The communication control circuits 52 manage the radio and communication resources used by the base station 40. The communication control circuits 52 are responsible for setting up, maintaining and tearing down communication channels between the RBS 36 and mobile station 100. The communication control circuits 52 may also allocate Walsh codes and perform power control functions. The communication control circuits 52 may be implemented in software, hardware, or some combination of both. For example, the communication control circuits 52 may be implemented as stored program instructions executed by one or more microprocessors or other logic circuits included in BSC 34.

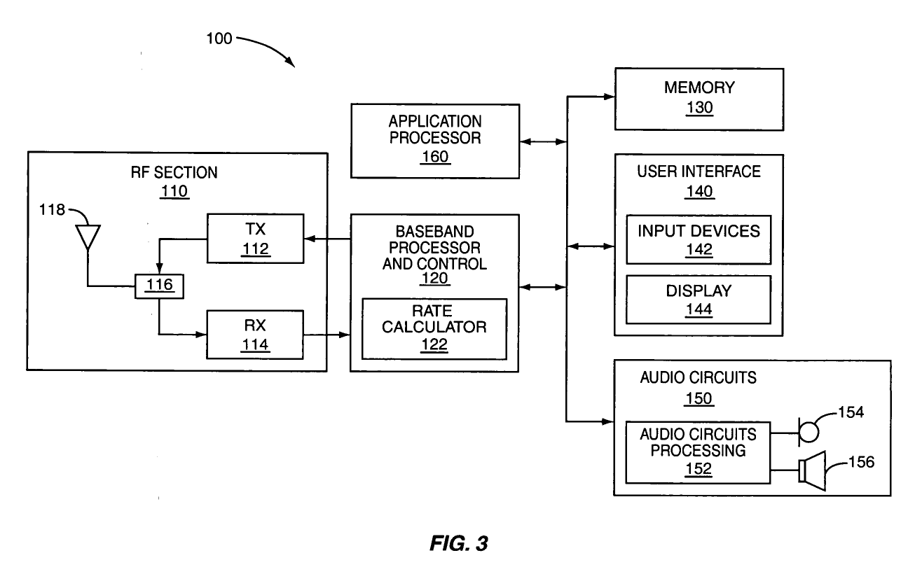

FIG. 3 illustrates details of an exemplary mobile station 100. The mobile station 100 includes an RF section 110, baseband processing and control circuits 120, memory 130, user interface 140, audio circuits 150, and an application processor 160. RF section 110 provides a radio interface for communicating with base stations 40. The RF section 110 includes a transmitter 112 and receiver 114 coupled to a shared antenna 118 through an RF switch 116. Transmitter 112 modulates transmitted signals onto an RF carrier and amplifies the transmit signal for transmission. Receiver 114 filters, amplifies, and downconverts received signals to baseband for processing by the baseband processing and control circuits 120. The baseband processing and control circuits 120 perform baseband processing for signals transmitted from, and received by, the mobile station, and control the overall operation of the mobile station 100. The baseband processing and control circuits 120 may comprise one or more processors, hardware, firmware, or a combination thereof. The baseband processing and control circuits 120 include a signaling processor 122 that performs signaling tasks required by applicable standards, such as rate control signaling.

Memory 130 stores programs and data used by the baseband processing and control circuits 120 and application processor 160. Memory 130 may take the form of one or more memory devices and may include both random access memory (RAM) and read-only memory (ROM). Computer programs and data required for operation of the device are typically stored in non-volatile memory, such as EPROM, EEPROM, and/or flash memory. The memory devices may be implemented as discrete devices, stacked devices, or integrated with processors in the baseband processing and control circuits 120.

User interface 140 typically includes one or more input devices 142 and one or more displays 144. The input devices 142 typically take the form of a keypad, joy stick control, touch pad, dial, and/or any other known type of input device. Display 144 typically takes the form of a conventional LCD, but may alternatively take the form of a touch screen display that also serves as an input device 142.

Audio circuits 150 include audio processing circuits 152, microphone 154, and speaker 156. Audio processing circuits 152 include D-to-A converters to convert digitized audio to analog signals suitable for output to speaker 156, and analog-to-digital converters for converting analog input signals from microphone 154 to digitized audio suitable for input to the baseband processing and control circuits 120. Microphone 154 converts the user's speech and other audible signals into electrical audio signals, and speaker 156 converts analog audio signals into audible signals that can be heard by the user.

Application processor 160 runs installed user applications, such as personal information management (PIM) applications, email applications, and instant messaging applications, as is well known in the art.

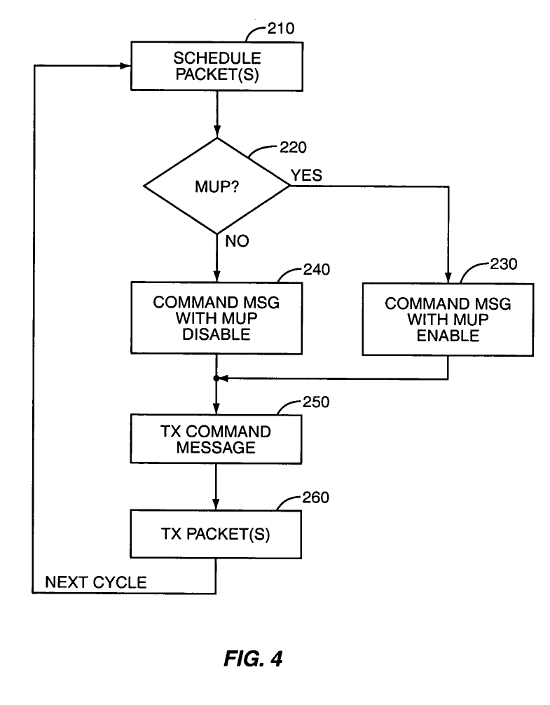

FIG. 4 illustrates a process flow for a base station according to one embodiment of the present invention. As is customary, the scheduler 60 determines if it is appropriate to send multi-user packets on the downlink packet data channel (step 210). If multi-user packets are to be transmitted (step 220), the baseband processing and control circuits 44 prepare a command message 290 (step 230) that includes an indication 296 that multi-user packet processing may be enabled at the mobile stations 100. If no multi-user packets are to be transmitted (step 220), the baseband processing and control circuits 44 prepare a command message 290 (step 240) that includes an indication 296 that multi-user packet processing is to be disabled at the mobile stations 100. Either way, the command message is then transmitted in a point-to-multipoint fashion (PTM) to all the mobile stations 100 in a sector being served by that base station 40 (step 250). Typically, this is accomplished by transmitting the command message on the packet data control channel (PDCCH). The relevant packets are then transmitted on the downlink packet data (traffic) channel (step 260), and the process begins again. Thus, the base station 40 transmits the multi-user packet processing enable/disable indicator to the mobile stations 100 each control channel cycle.

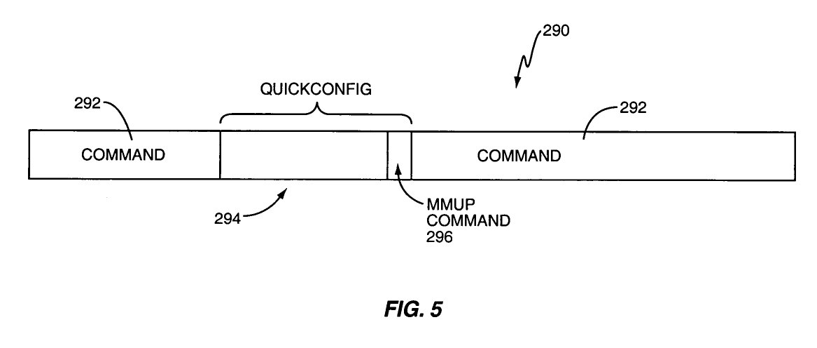

The multi-user packet processing enable/disable indicator may, in some embodiments, be a simple one-bit flag in the command message 290, with a value of “0” indicating multi-user packet detection is to be disabled and a value of “1” indicating that multi-user packet detection is to be allowed. For example, a one-bit field 296 may be added to the existing QUICKCONFIG message field 294 in the current IS-856 Rev. A standard. The resulting command message 290 may be as shown in FIG. 5, with the indicator 296 appended to the balance of the QUICKCONFIG message 294, which is bundled with the other portions 292 of the command message 290. For ease of reference, this multi-user packet processing enable/disable indicator 296 discussed immediately above may be referred to herein as a multipoint multi-user packet command (MMUP command) 296.

From the perspective of the mobile station 100, the sector-wide MMUP command 296 may be view as an augmentation to any existing settings related to multi-user packets. For example, the MMUP command 296 may be logically ANDed with the MultiUserPacketsEnabled attribute to determine if the mobile station 100 will process multi-user packets. Thus, if both the MMUP command 296 and the MultiUserPacketsEnabled attribute indicate that the mobile station 100 should process multi-user packets, then the mobile station 100 processes the multi-user packets (e.g., blind rate detects and decode them) to see if they contain any data intended for the mobile station 100. On the other hand, if either the MultiUserPacketsEnabled attribute or the MMUP command 296 (or both) indicate that the mobile station 100 should not process multi-user packets, then the mobile station 100 may ignore any packets not targeted only at that mobile station, including any multi-user packets, as soon as they are identified.

As is understood, a multi-user packet is typically identified by the presence of one of a few (e.g., five) selected MAC indexes in the packet preamble, while a single-user packet is indicated by a MAC index assigned to the targeted mobile station. Thus, a mobile station 100 that has been commanded to ignore multi-user packets, due to the MMUP command or the MultiUserPacketsEnabled attribute, need only determine if the packet preamble has a single known MAC index—the one corresponding to the MAC expected by the mobile station 100 based on its channel feedback information. If so, the packet should be further processed, if not, the packet may be disregarded. In contrast, a mobile station 100 that has multi-user packet processing enabled must determine if a given packet has that MAC index or any of the multi-user MAC indexes. Therefore, having the multi-user packet processing disabled is less computationally complex, and therefore consumes less battery power.

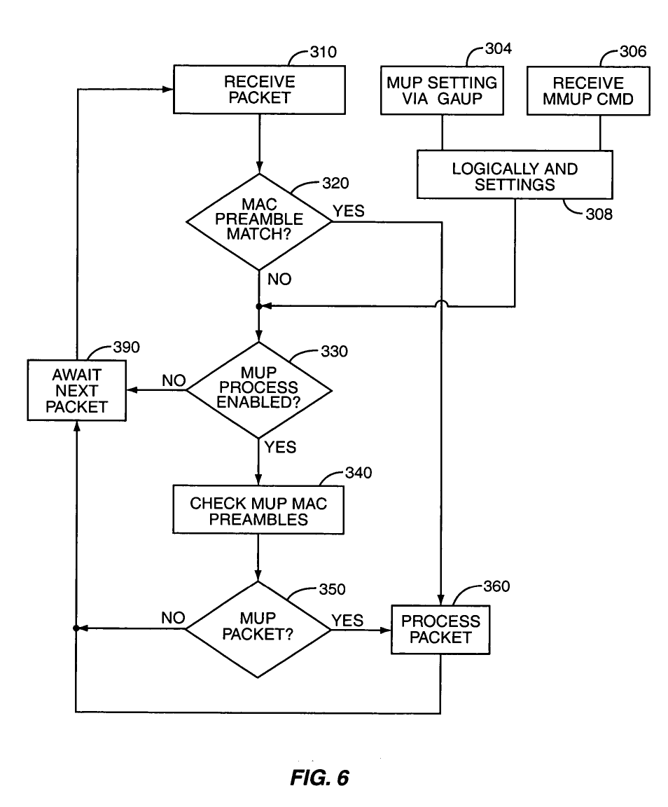

FIG. 6 illustrates a process flow for a mobile station 100 according to one embodiment of the present invention. The mobile station 100 is configured by the base station 40 on an individual basis via the GAUP process for the MultiUserPacketsEnabled attribute (step 304). In the absence of an explicit setting, the mobile station 100 may have a default of not enabled. The mobile station 100 also receives the MMUP command 296 from the base station 40 on the packet data control channel (step 306) in a PTM message. The mobile station 100 logically ANDs these two settings to determine whether multi-user packet processing is enabled for the current control channel cycle (step 308). Somewhat separately, the mobile station 100 receives the packets on the downlink packet data (traffic) channel (step 310). The mobile station 100 checks to see if the MAC index in the preamble matches the MAC index for that mobile station (step 320) in a fashion known in the art. If the MAC index matches, the packet is a “single-user” packet and intended for that mobile station. As such, the packet is passed on for further conventional processing (step 360). If the MAC index does not match, the mobile station 100 checks to see if multi-user processing is enabled (step 330). If not, because one or both of the MultiUserPacketsEnabled attribute of the MMUP command are negative, the mobile station 100 disregards the packet and moves on to the next packet (step 390). If multi-user packet processing is enabled, then the mobile station 100 checks the MAC index against a list of pre-determined MAC indexes that are reserved for indicating the present of multi-user packets (step 340). If the MAC index is not on that list, the packet is not a multi-user packet; if the MAC index is on that list, then the packet is a multi-user packet. If the packet is a multi-user packet (step 350), the packet passed on for further processing to see if the packet contains data for that mobile station (step 360). If the packet is not a multi-user packet (step 350), the packet is disregarded and the mobile station 100 moves on to the next packet (step 390).

The ability of the base station 40 to send a PTM command that disables multi-user packet processing for multiple mobile stations 100 in a sector with a single command transmission greatly increases the flexibility of the base stations 40 to dynamically respond to changing situations, without the burden of having to instruct each mobile station 100 individually. Further, the present invention allows the base station 40 to enable multi-user packet processing in individual mobile stations 100 via GAUP process, but temporarily disable the functionality via the MMUP command 296 (set to disable) when multi-user packets are not being transmitted.

The discussion above has indicated that the MMUP command 296 is transmitted from the base station 40 to the mobile terminals 100 in a point-to-multipoint (PTM) fashion, i.e., where the MMUP command 296 is simultaneously transmitted from a single source (the base station 40) to multiple users (multiple mobile stations 100) over a common channel. It should be noted that this PTM transmission may be a “broadcast” or a “multicast,” as is desired. A distinction is sometimes drawn between broadcasting and multicasting. The distinction is that a broadcast stream is typically offered to all users in a sector, while a multicast stream is offered to a special multicast group of two or more users. Broadcast and multicast services are both PTM (point-to-multipoint) transmissions. Thus, if it is desired to disable multi-user packet detection in all the mobile stations 100 in a sector (i.e., being served by the base station 40), the base station 40 may transmit the MMUP command 296 as a broadcast message. This scheme is believed advantageous. However, in some instances, it may be beneficial to disable the multi-user packet detection in only a select group of such mobile stations 100. For such situations, the base station 40 may transmit the MMUP command 296 as a multicast message to the multicast group that contains the relevant mobile stations 100.

The discussion above has been assumed that the base station 40 has a single carrier frequency for downlink packet data transmissions. However, some base stations 40 may transmit downlink packets to mobile stations on multiple carrier frequencies. For such situations, the MMUP command 296 may indicate whether multi-user packet detection is to be disabled or allowed separately for each carrier frequency. Thus, the MMUP command 296 may be multi-bit command, with each bit representing the disable/allowed state for the corresponding carrier frequency. For such situations, it may be advantageous for the base station 40 to transmit the MMUP command 296 as part of control messages on an anchor carrier frequency, if one of the multiple carrier frequencies is designated as such.

As used herein, the term “mobile station” 40 may include a cellular radiotelephone, a Personal Communications System (PCS) terminal that may combine a cellular radiotelephone with data processing, facsimile, and data communications capabilities; a Personal Data Assistant (PDA) that may include a pager, Web browser, radiotelephone, Internet/intranet access, organizer, calendar, and a conventional laptop and/or palmtop receiver or other appliances that include a radiotelephone transceiver.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of operating a base station, the base station operative to transmit multi-user packets on a downlink packet data traffic channel shared by a plurality of mobile stations, comprising:
collectively disabling a multi-user packet detection process of a plurality of mobile stations by transmitting a first downlink point-to-multipoint command message from a base station to the plurality of mobile stations in a point-to-multipoint fashion.

2. The method of claim 1 wherein said first downlink point-to-multipoint command message is transmitted on a packet data control channel.

3. The method of claim 2 wherein said first downlink point-to-multipoint command message is transmitted on a packet data control channel as a QUICKCONFIG message.

4. The method of claim 1 wherein said collectively disabling said multi-user packet detection process by said plurality of mobile stations comprises collectively disabling said multi-user packet detection process by said plurality of mobile stations for a control cycle duration.

5. The method of claim 1 further comprising subsequently collectively allowing said multi-user packet detection process by said plurality of mobile stations by transmitting a second downlink point-to-multipoint command message from said base station to said plurality of mobile stations in a point-to-multipoint fashion.

6. The method of claim 1 wherein said plurality of mobile stations comprise all of the mobile stations in a sector being served by the base station.

7. The method of claim 1 wherein said multi-user packet detection process comprises checking, at a mobile station of said plurality of mobile stations, a portion of packet preamble against a predetermined list of possible values that indicate the presence of a multi-user packet.

8. The method of claim 1 wherein said first downlink point-to-multipoint command message is transmitted on less than all of a plurality of carrier frequencies used by said base station to transmit downlink packet data.

9. The method of claim 1 wherein said transmitting said downlink point-to-multipoint command message comprises transmitting said downlink point-to-multipoint command message using code division multiplexing.

10. The method of claim 1:
wherein said first downlink point-to-multipoint command message is transmitted on a packet data control channel using code division multiplexing;
wherein said collectively disabling said multi-user packet detection process by said plurality of mobile stations comprises collectively disabling said multi-user packet detection process by said plurality of mobile stations for a control cycle duration;
further comprising subsequently collectively allowing said multi-user packet detection process by said plurality of mobile stations by transmitting a second downlink point-to-multipoint command message from said base station to said plurality of mobile stations in a point-to-multipoint fashion.

11. A method of operating a base station, the base station operative to transmit multi-user packets on a downlink packet data traffic channel shared by a plurality of mobile stations, comprising:
setting a command indicator to a first value that instructs mobile stations, in response to receiving said command indicator, to disable multi-user packet detection for subsequently received packets;
transmitting said command indicator in a point-to-multipoint message from said base station to said plurality of mobile stations.

12. The method of claim 11 wherein said point-to-multipoint message is transmitted on a packet data control channel.

13. The method of claim 11 wherein transmitting said command indicator comprises transmitting said command indicator as a portion of a QUICKCONFIG message on a packet data control channel.

14. The method of claim 11 further comprising subsequently changing said command indicator to a second value that instructs mobile stations to allow multi-user packet detection for subsequently received packets; and transmitting said changed command indicator in a second point-to-multipoint message from said base station to said plurality of mobile stations.

15. The method of claim 11:
wherein transmitting said command indicator in a point-to-multipoint message from said base station to said plurality of mobile stations comprises transmitting said command indicator in said point-to-multipoint message from said base station to said plurality of mobile stations using code division multiplexing; and
further comprising subsequently changing said command indicator to a second value that instructs mobile stations to allow multi-user packet detection for subsequently received packets; and transmitting said changed command indicator in a second point-to-multipoint message from said base station to said plurality of mobile stations.

16. A method of handling multi-user packets transmitted on a downlink packet data channel shared by a plurality of mobile stations, comprising:
receiving a first point-to-multipoint message from a base station; said first message having a command indicator that instructs receiving mobile stations, in response to said command indicator, to disable multi-user packet processing;
disabling, at the mobile station, a multi-user packet detection process for one or more subsequently received packets based on said command indicator.

17. The method of claim 16 wherein said disabling said multi-user detection process comprises disabling said multi-user detection process for a control channel cycle.

18. The method of claim 16 wherein said multi-user packet detection process comprises checking a portion of a packet preamble against a predetermined list of possible values that indicate the presence of a multi-user packet.

19. The method of claim 16 wherein said receiving said first point-to-multipoint message from said base station comprises receiving said first point-to-multipoint message on a code division multiplexed packet data control channel.

20. The method of claim 16 wherein said command indicator forms a portion of a QUICKCONFIG message on a code division multiplexed packet data control channel.

21. The method of claim 16 wherein said receiving said first point-to-multipoint message from said base station comprises receiving said first point-to-multipoint message transmitted on less than all of a plurality of carrier frequencies used by said base station to transmit downlink packet data.

22. The method of claim 16 further comprising subsequently receiving a second point-to-multipoint message from said base station; and, in response to said second message, enabling said multi-user packet detection process.

23. The method of claim 16 further comprising setting a first attribute to a first logical value in response said receiving; and wherein enablement of said multi-user detection process depends on a logical ANDing said first attribute and a second attribute associated with multi-user packets, the second attribute set according to a point-to-point message received from said base station by said mobile station.

24. The method of claim 16:
wherein said receiving said first point-to-multipoint message from said base station comprises receiving said first point-to-multipoint message on a code division multiplexed packet data control channel;
further comprising setting a first attribute to a first logical value in response said receiving said first point-to-multipoint message; and wherein enablement of said multi-user detection process depends on a logical ANDing said first attribute and a second attribute associated with multi-user packets, the second attribute set according to a point-to-point message received from said base station by said mobile station;
wherein said disabling said multi-user detection process comprises disabling said multi-user detection process for a control channel cycle;
wherein said multi-user packet detection process comprises checking a portion of a packet preamble against a predetermined list of possible values that indicate the presence of a multi-user packet.

25. A base station for a wireless communications system, comprising:
a transmitter operative to transmit to a plurality of mobile stations; and
one or more processing circuits operatively coupled to said transmitter and configured to:
collectively disable a multi-user packet detection process of said plurality of mobile stations by causing said transmitter to transmit a first downlink point-to-multipoint command message to the plurality of mobile stations in a point-to-multipoint fashion.

26. The base station of claim 25 wherein said one or more processing circuits are configured to cause said transmitter to transmit said first downlink point-to-multipoint command message on a packet data control channel.

27. The base station of claim 26 wherein said one or more processing circuits are configured to cause said transmitter to transmit said first downlink point-to-multipoint on a code division multiplexed packet data control channel as a portion of a QUICKCONFIG message.

28. The base station of claim 25 wherein said one or more processing circuits are configured to cause said transmitter to transmit said first downlink point-to-multipoint command message on less than all of a plurality of carrier frequencies used by said base station to transmit downlink packet data.

29. The base station of claim 25 wherein said one or more processing circuits are configured to subsequently collectively allow said multi-user packet detection process by said plurality of mobile stations by causing said transmitter to transmit a second downlink point-to-multipoint command message to said plurality of mobile stations in a point-to-multipoint fashion.

30. The base station of claim 26 wherein said plurality of mobile stations comprise all of the mobile stations in a sector being served by the base station.

31. A wireless communications mobile station, comprising:
a receiver operative to receive transmissions, including downlink packet data packets, from a base station; and
one or more processing circuits operatively coupled to said receiver and configured to:
disable a multi-user packet detection process at said mobile station for one or more subsequently received packets in response to receiving a first point-to-multipoint message from a base station.

32. The mobile station of claim 31 wherein said multi-user packet detection process comprises checking a portion of a packet against a predetermined list of possible values that indicate the presence of a multi-user packet.

33. The mobile station of claim 31 wherein said multi-user packet detection process comprises checking MAC index portion of said packet against said predetermined list of possible values that indicate the presence of a multi-user packet.

34. The mobile station of claim 31 wherein said one or more processing circuits are further configured to allow said multi-user packet detection process in response to subsequently receiving a second point-to-multipoint message from said base station.

35. The mobile station of claim 31 wherein said receiver is operative to receive said first point-to-multipoint message from said base station on a packet data control channel.

36. The mobile station of claim 31 wherein first point-to-multipoint message comprises a QUICKCONFIG message having a command indicator therein; and wherein said one or more processing circuits are further configured to disable said multi-user packet detection process in response to said command indicator having a first value.

37. The mobile station of claim 31 wherein said receiver is operative to receive said first point-to-multipoint message from said base station on one of a plurality of carrier frequencies used by said base station to transmit downlink packet data to said plurality of mobile stations.

38. The mobile station of claim 31 wherein said one or more processing circuits are further configured to set a first attribute to a first logical value in response said receiving said first point-to-multipoint message; and wherein said one or more processing circuits are further configured to disable said multi-user detection process based on a logical ANDing said first attribute and a second attribute associated with multi-user packets; said second attribute set based on a command received from said base station in a point-to-point message.
